(19) United States
(12) Patent Application Publication
(10) Pub. No.: US 2011/0064944 A1
(43) Pub. Date: Mar. 17, 2011

(54) Ferromagnetic block polymers and related methods

(76) Inventors: Gregory N. Tew, Amherst, MA (US); Raja Shunmugam, Amherst, MA (US); Zoha Al-Badri, Wilmington, DE (US); Thomas P. Russell, Evanston, IL (US)

(21) Appl. No.: 12/229,431

(22) Filed: Aug. 22, 2008

Related U.S. Application Data
(60) Provisional application No. 60/965,803, filed on Aug. 22, 2007.

(51) Int. Cl. B32B 3/00; C07F 15/06; H01F 1/00; C08G 73/00

(52) U.S. Cl. 428/339; 548/404; 525/50; 525/196; 252/62.55

(57) ABSTRACT

Ferromagnetic multi-block copolymers of the sort which can be used to provide high-density, highly ordered thin films, composites and related articles.

This application claims priority benefit of application Ser. No. 60/965,803, filed Aug. 22, 2007, the entirety of which is incorporated herein by reference.

The United States government has certain rights to this invention pursuant to Grant No. ARO W911NF-04-1-0191 from the Army Research Office to the University of Massachusetts.

### BACKGROUND OF THE INVENTION

Ordered arrays of magnetic materials, as can be provided on substrates and in conjunction with other composites or article configurations, are useful in various applications such as high-density magnetic storage media and magnetic-based sensors. As the microelectronics industry continues to reduce component dimension, ultra high-density arrays of nanoscale elements hold promise for significant advancement of future technologies. However, parallel fabrication of well-ordered magnetic arrays, in a controlled manner, has proven difficult.

Several approaches have employed materials such as porous aluminum oxide, ion-track-etched polycarbonate and ion-track-etched mica—each with limited success. More recently, ultra high-density magnetic nanoarrays or nanoclusters have been produced within a self-assembled diblock copolymer matrix. However, as described in U.S. Pat. Nos. 7,190,049 and 6,991,741, such arrays are available only through multi-step processes. Even then, upon diblock assembly, additional steps and procedures are required to incorporate a ferromagnetic metal or a metal oxide precursor into the copolymer matrix. As such, there remains an on-going search in the art for a facile and efficient approach toward an ordered array of such magnetic materials.

### SUMMARY OF THE INVENTION

In light of the foregoing, it is an object of the present invention to provide polymeric materials comprising ferromagnetic order or an array of such components, related composites and/or methods for their preparation and/or assembly, thereby overcoming various deficiencies and shortcomings of the prior art, including those outlined above. It will be understood by those skilled in the art that one or more aspects of this invention can meet certain objectives, while one or more aspects can meet certain other objectives. Each objective may not apply equally, in all its respects, to every aspect of this invention. As such, the following objects can be viewed in the alternative with respect to any one aspect of this invention.

It can be an object of the present invention to provide a phase-separated polymeric material providing a distinct ferromagnetic phase, whether ordered or disordered.

It can be another object of this invention to provide a process for the production of ultra high-density arrays of such ferromagnetic materials.

It can be another object of the present invention to provide a facile process for the assembly of a ferromagnetic phase or array within the context of a polymeric architecture.

It can also be an object of the present invention, alone or in conjunction with one or more of the preceding objectives, to provide a metal component within such a polymeric material exhibiting ferromagnetic and oxidative stability over the course of end-use application

Other objects, features, benefits and advantages of the present invention will be apparent from this summary and the following descriptions of certain embodiments, and will be readily apparent to those skilled in the art having knowledge of ferromagnetic properties, polymeric materials and related assembly/production techniques. Such objects, features and advantages will be apparent from the above as taken into conjunction with the accompanying examples, data, figures and all reasonable inferences to be drawn therefrom.

In part, the present invention can be directed to a multi-block (b) copolymer, as can comprise or be of a formula P_{R}-b-P′_{R1}, where P can be a first polymeric block comprising a first monomeric component comprising a metal complex pendent thereto; and P′ can be a second polymeric block comprising a second monomeric component comprising a group R₁ pendent thereto, with R₁ selected from hydrophobic and hydrophilic groups and at least partially sufficient to induce phase separation within such a copolymer. R can be a precursor to a ferromagnetic metal M and can comprise one or more, optionally labile, ligands. In certain embodiments, R—where hydrophobic—can be selected from about C₅ to about C₂₄ alkyl moieties and about C₅ to about C₂₄ substituted alkyl moieties. Corresponding hydrophilic moieties can be as are known to those skilled in the art. Regardless, M can be selected from a ferromagnetic metal. In certain such embodiments, M can be selected from Fe, Co, Pd and Ni and from any other common magnetic metals. Notwithstanding identity of R, R₁ or M, monomeric components of each block can be selected as would be understood by those skilled in the art to provide a range of other di- or other multi-block copolymers and are compositionally limited only by structural design and desired end-use physical or performance properties. Without limitation, any such block and/or resulting copolymer can be a ring-opening metathesis copolymerization product. Representative of such products, one or more polymeric blocks P and P′ can comprise a poly(oxanorbornene). Illustrating but one such product comprising poly(oxanorbornene) blocks, a copolymer of this invention can be of a formula

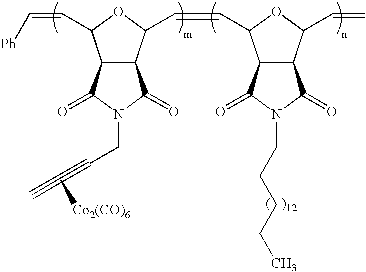

In certain embodiments, as shown, M can be chelated to, complexed or otherwise associated with one or more carbonyl ligands, depending on valence considerations. Such copolymers can be spin-coated on a substrate or cast as a film, with long-range alignment provided using methods and techniques well-known to those skilled in the art made aware of this invention. In certain such embodiments, such a copolymer can be heated for at least one of a time and at a temperature at least partially sufficient to remove the carbonyl ligand(s), and provide M and the corresponding polymer ferromagnetic properties. Choice of hydrophobic/hydrophilic group can be used to provide a multi-phase material, for subsequent incorporation into any article of manufacture utilizing a ferromagnetic phase of the type described herein.

Accordingly, in part, the present invention can also be directed to a multi-phase multi-block (b) copolymeric composition or material, as can comprise a heat treated product of a polymer of a formula P_{R}-b-P′_{R1}, as discussed above. Such a composition or material, without limitation as to block number (e.g., diblock or triblock, etc.) or block identity can comprise a phase comprising a ferromagnetic metal, M. In certain embodiments, where hydrophobic, R₁ can be selected from C₅ to about C₂₄ alkyl moieties and from about C₅ to about C₂₄ substituted alkyl moieties. Regardless, without limitation, M can be selected from Fe, Co and Ni. In certain embodiments, M can be Co, and one or more polymeric blocks P and P′ can comprise poly(oxanorbornene) blocks. Without limitation as to block or ferromagnetic metal identity, such a material can be incorporated into an article of manufacture. In certain such embodiments, such material can be coupled to or deposited on a substrate component.

In part, the present invention can also be directed to a method of using copolymerization to provide a ferromagnetic phase or domain of a polymer. Such a method can comprise providing a first monomeric component comprising a phase-separating hydrophobic or hydrophilic group pendent thereto, and a second monomeric component comprising a ferromagnetic metal complex pendent thereto, such a complex as can comprise one or more labile ligands; block copolymerizing the monomeric components to provide such a copolymer phase comprising such a ferromagnetic metal complex; and treating the block copolymer with an agent (e.g., without limitation, heat) at least partially sufficient to provide such a copolymer a phase comprising a ferromagnetic metal. Such monomeric components and resulting copolymers can be as described herein or as would be otherwise understood by those skilled in the art made aware of this invention. Identity, number and/or relative amounts of any such monomeric component is limited only by design and/or desired end-use physical or performance properties. Phase separation can be achieved with or in conjunction with copolymerization, through processing and/or under corresponding cure conditions.

Without limitation, in certain embodiments, a complex of the sort mentioned above can comprise carbonyl ligands, and an agent comprising heat treatment for at least one at a time and at a temperature at least partially sufficient to remove the carbonyl ligand(s) can be used to effect ferromagnetism of the corresponding metal. As demonstrated elsewhere herein, such a method can comprise depositing (e.g., spin-coating or casting) the copolymer on a substrate component or otherwise incorporating such a copolymer into an article of manufacture, before or during treatment to remove the carbonyl or other ligands.

### BRIEF DESCRIPTION OF THE DRAWINGS

FIG. 1 shows a synthetic route to provide multi-phase multi-block copolymers, in accordance with certain embodiments of this invention.

FIGS. 2A-B provides TEM micrographs of a non-limiting block copolymer before (2A) and after (2B) heat treatment.

FIGS. 3A and 3B illustrate ferromagnetic properties of a representative block copolymer (3A), as compare to a paramagnetic homopolymer (3B).

FIGS. 4-10 provide small angle x-ray scattering and TEM micrographs for a representative block copolymer of this invention, over a mole-fraction range, illustrating corresponding change in morphology.

FIG. 11 is a TEM micrograph of an article/composite comprising of a high-density thin film of a block copolymer of example 13, exhibiting a highly-ordered cylindrical ferromagnetic phase.

### DETAILED DESCRIPTION OF CERTAIN EMBODIMENTS

As mentioned above, the present invention provides block copolymer pre-programmed with the necessary chemical information to microphase separate and deliver room temperature ferromagnetic properties upon a simple heat treatment, in conjunction with film deposition, casting and/or alignment, to convert a ferromagnetic precursor to a ferromagnetic domain/material. The utility of nanoscopic structural components is demonstrated by comparison with a corresponding homopolymer which shows only paramagnetism even though it is of identical chemistry and has a higher metal loading. In addition, the in situ generation of the ferromagnetic elements densely functionalizes the metal surface, improving oxidative stability.

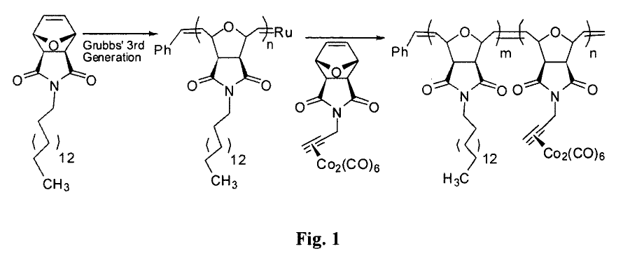

Illustrating but one embodiment of this invention, a metal-containing block copolymer—for instance, based on poly(oxanorbornene) where one block is functionalized with a hexadecyl chain and the other with dicobalt hexacarbonyl (Co₂(CO)₆), denoted PON_{C16}-b-PON_{Co}—is shown to microphase separate into nanoscopic domains of PON_{Co} that become ferromagnetic when thermally treated to remove the carbonyl ligands forming nanoparticles or nano-dimensioned phase(s) of cobalt metal. (See, e.g., FIG. 1.) By comparison, PON_{Co}, a corresponding homopolymer, treated in exactly the same manner, is paramagnetic with cobalt particles uniformly dispersed throughout the material.

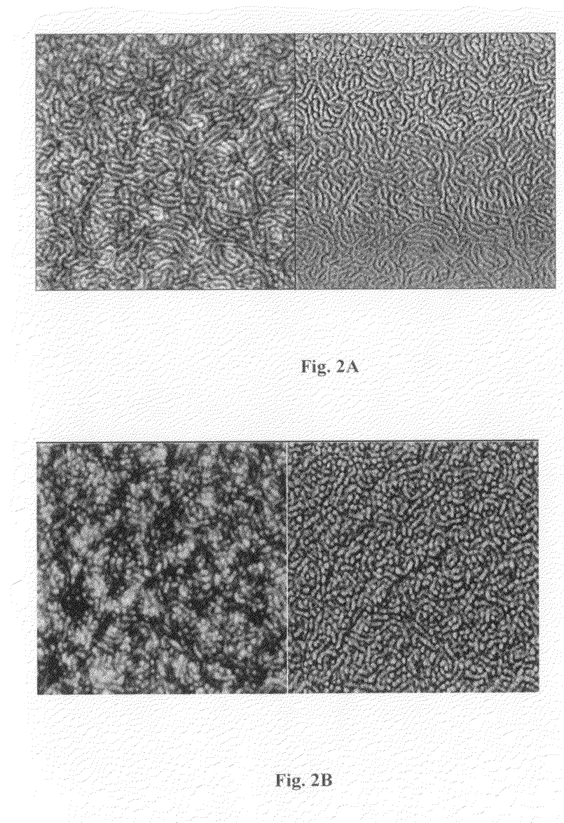

Spin coated films of PON_{C16}-b-PON_{Co}, while smooth, were, microphase separated, as evidenced by the scanning force microscopy, small angle x-ray scattering and transmission electron microscopy (TEM), with an average center-to-center distance between the microdomains of 32 nm. (FIG. 2A) By heating to up to about 200° C. (polymer backbone degradation began at ˜300° C.), the carbonyl ligands from the cobalt complex are lost, producing cobalt metal. With PON_{C16}-b-PON_{Co}, cylindrical or rod-like domains of cobalt are seen (FIG. 2B). In contrast, PON_{Co}, heated to 200° C. for 2 h, provides a disordered array of cobalt nanoparticles with an average diameter of <5 nm. Reference is made to one or more of the accompanying figures and TEM images provided therewith for various dimensional aspects relating to the present copolymers and/or arrays thereof. Without limitation, a cylindrical ferromagnetic phase can be dimensioned from about 2 to about 100 nm in diameter with dimensions of about 5 to about 50 nm available in certain such embodiments. Cylinder height can vary, without limitation, with copolymer thickness and related processing conditions.

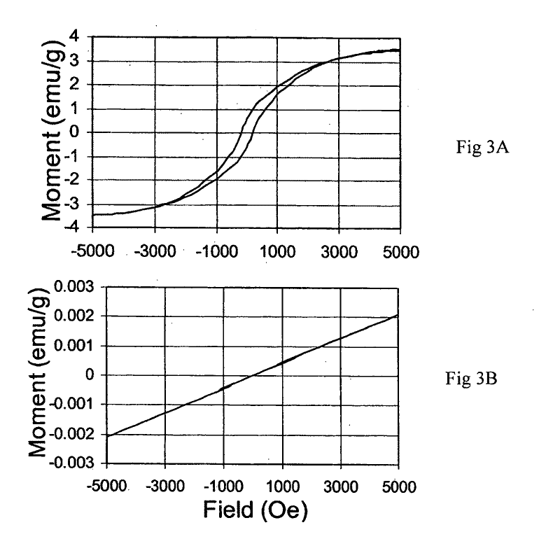

Using a superconducting quantum interference device (SQUID) magnetometer, the magnetic properties of such thermally annealed materials were measured. The PON_{C16}-b-PON_{Co} film was ferromagnetic at room temperature as shown in FIG. 3A. (Again, in contrast, the PON_{Co} film to be paramagnetic, with zero magnetization in the absence of the magnetic field; FIG. 3B.) Representative saturation magnetization (Mₛ), remnant magnetization (Mᵣ), and coersivity (H_{c}) were found to be 3.5 emu/g, 0.61 emu/g, and 200 Oe, respectively. The H_{c} of the nanostructured copolymer is 20 times larger than that of continuous cobalt films (H_{c}=10 Oe) consistent with the enhanced H_{c} demonstrated by cobalt nanoparticles. The nanostructured material produced from PON_{C16}-b-PON_{Co} are also environmentally stable over extended time periods. By comparison, the homopolymer is paramagnetic and does not respond to a bar magnet, while samples of a diblock copolymer 3 are strongly attracted. Thin coatings on a Kapton film can also be picked up with a magnet. The magnetization of a diblock copolymer of FIG. 1 was maintained and remained the same over months of testing.

Certain aspects of various embodiments of this invention can be considered with the preparation of representative monomers, polymeric blocks and resulting copolymers. Synthetic techniques of the sort useful in the context of this invention, with reference to examples 6-12, are shown in schemes 1-5, below. For instance, monomers 1a and 1b (Scheme 1) were prepared via Mitsunobu coupling. (See, Booker-Milburn, K. I.; et al., A. Eur. J. Org. Chem. 2001, 1473, 000.) Treatment of the corresponding alcohol (e.g., R is C₂ to about C₂₄ alkyl or substituted alkyl) derivatives with exo-10-oxa-4-azatricyclo[5.2.1.0^{2,6}dec-8-ene-3,5-dione (1) in the presence of triphenylphosphine and diisopropylazodicarboxylate (DIAD) afforded the corresponding functionalized monomers 1a (R is a C₃ acetylenic moiety) and 1b (e.g., a hydrophilic R₁) in 90% and 65% yield, respectively. (Various other oxanorbornene compounds substituted with a range of acetylenic moieties can be prepared with the corresponding C₄-C₂₄ alcohol.) Monomer 1c (e.g., R₁ is a C₅ alkyl) was prepared in 80% yield by nucleophilic substitution of 1 with 1-bromopentane using DMF/K₂CO₃.

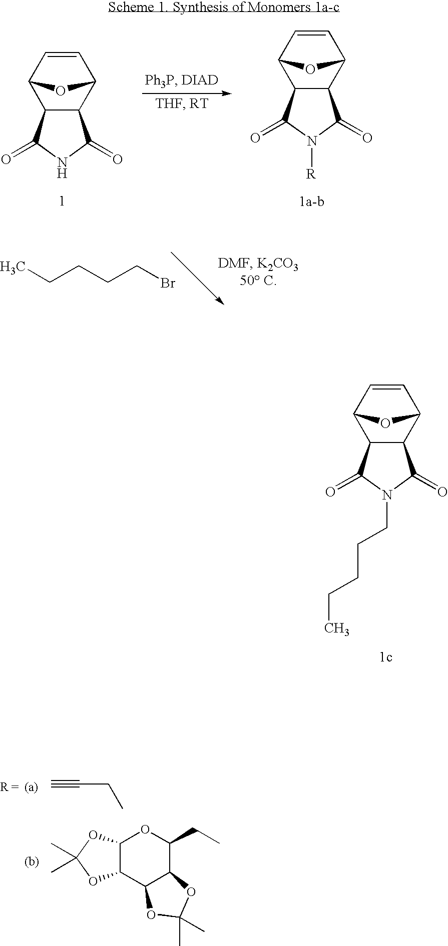

Monomer 1a was treated with dicobalt octacarbonyl to afford 2a in 75% yield (Scheme 2) which was confirmed by NMR. The ¹³C NMR spectrum of complex 2a (not shown) gave rise to a new peak due to the carbonyls of the cobalt complex. At the same time, the signals for the acetylenic and the methylene carbons also shifted downfield. Monomer 2a is readily soluble in common organic solvents such as THF, CHCl₃, and CH₂Cl₂ due to the neutral metal complex.

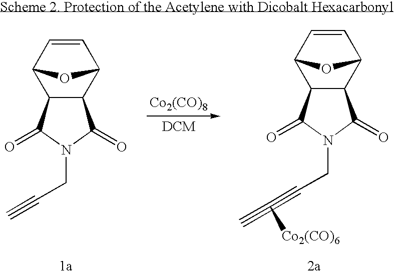

Third generation Grubbs' catalyst was used to polymerize monomer 2a (Scheme 3), and the polymerization was initially monitored by NMR. After 8 min, polymerization was complete as indicated by the disappearance of the vinyl proton signal and the emergence of the trans and cis vinyl proton resonances. In agreement, the ¹³C NMR analysis showed the loss of the vinyl carbon signals and the appearance of a new broad peak that was attributed to the carbon double bonds of the polymer backbone. There was no change in the carbon signals of the acetylene moiety after polymerization. Beyond NMR, GPC analysis of the heavily metalized polymer 3 showed a monomodal distribution of MWs with a narrow PDI of 1.09. Accordingly, this invention demonstrates the compatibility of the third generation Grubbs' catalyst with the present dicobalt hexacarbonyl complex.

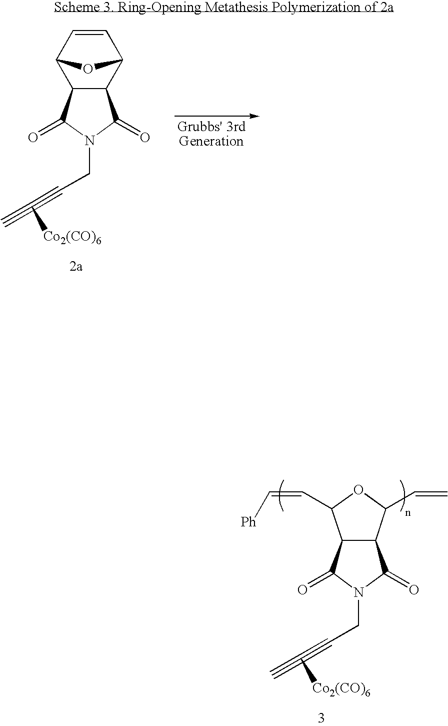

To examine a consideration related to certain embodiments, a series of homopolymers with different [M]/[I] ratios, and thus MW, were synthesized to evaluate the “livingness” of the polymerization. The results indicate that the polymerizations were well-controlled, resulting in narrow polydispersities for all samples, good isolated yields (85-90%), and MW's spanning 20-100 kDa. In all cases, the targeted number-average molecular weight (Mₙ) were close to the theoretical values, and the plot of Mₙ vs [M]:[I] ratio was linear, suggesting that the polymerizations were, indeed, living.

As further evidence that the polymerization of 2a was living, a block copolymer of this invention was synthesized via a two-step polymerization sequence according to Scheme 4. A 10:1 [M]:[I] ratio of monomer 2a was allowed to polymerize to completion after which 50 equiv of monomer 1b was added to the reaction. After complete consumption of monomer 1b, the AB block copolymer 4 was isolated by precipitation from pentane.

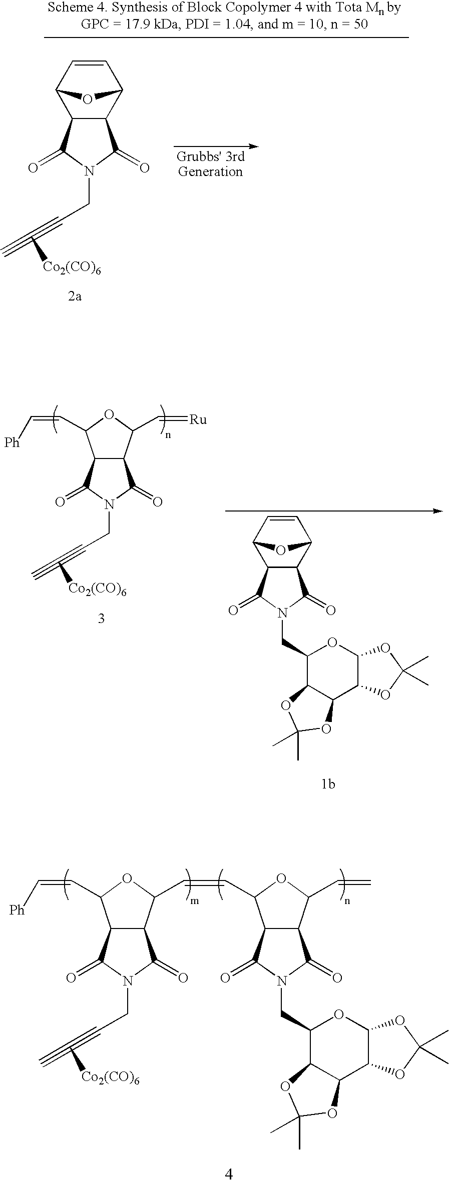

Using similar reaction conditions, another block copolymer, 5, was prepared (Scheme 5). A 10:1 [M]:[I] ratio of monomer 2a was polymerized to completion followed by the addition of 20 equiv of monomer 1c to afford a block copolymer with 1:2 molar ratio.

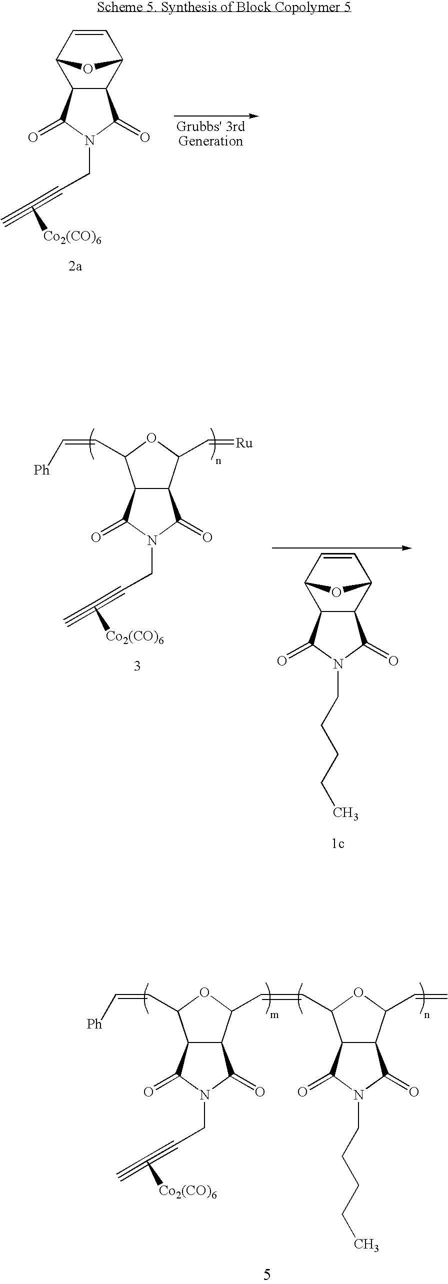

By combining the self-assembly of a metal-containing diblock copolymer into arrays of nanoscopic domains with a thermal conversion of the metal-containing block into the pure metal, a direct route is shown to fabricate high-density arrays of metal nanoparticles. The particle size is commensurate with the block copolymer microdomains and produces ferromagnetic properties not seen in the parent homopolymer. By controlling the diameter, aspect ratio, orientation and lateral ordering of the block copolymer microdomains in thin films, this invention provides a two-step route to ultra high-density magnetic media.

### EXAMPLES OF THE INVENTION

The following non-limiting examples and data illustrate various aspects and features relating to the monomers, multi-block copolymers, composites, articles and/or methods of the present invention, including the assembly and/or alignment of a phase-separated ferromagnetic material, as is available through the synthetic methodology described herein. In comparison with the prior art, the present monomer and copolymer compositions and/or methods provide results and data which are surprising, unexpected and contrary thereto. While the utility of this invention is illustrated through the use of several block copolymers and monomeric components and/or ferromagnetic metals and precursors which can be used therewith, it will be understood by those skilled in the art that comparable results are obtainable with various other monomers, metals (or precursors), multi-block copolymers and resulting compositions and articles, as are commensurate with the scope of this invention.

Instrumentation. NMR spectra were recorded on a Bruker DPX-300 MHz (¹H NMR; ¹³C NMR, 75 MHz) spectrometer. Chemical shifts are reported in δ (ppm), referenced to the ¹H (of residual protons) and ¹³C signals of deuterated solvents. Molecular weights and PDIs were measured by GPC in THF relative to polystyrene standards on systems equipped with two-column sets (Polymer Laboratories) and refractive-index detectors (HP1047A) at 40° C. with a flow rate of 1 mL/min. UV-vis spectra were obtained using a Perkin-Elmer Lambda 2 series spectrophotometer with PECSS software. IR spectra were obtained using a Bio-Rad FTS 3000 Excalibur Series.

Materials. All reagents were purchased either from Acros Organics, Aldrich, or Strem and used without further purification. Dichloromethane and THF were dried over CaH₂ and sodium benzophenone ketyl, respectively. Third generation Grubbs' catalyst (Louie, J.; Grubbs, R. H. Angew. Chem., Int. Ed. 2001, 40, 247) and exo-oxanorbornene 1 (Kwart, H.; Burchuk, I. J. Am. Chem. Soc. 1952, 74, 3094) were synthesized according to the literature.

### Example 1

Acetylene functionalized oxanorbornene. To a 500 mL round bottom flask charged with 10.0 g (60.6 mmole) of exo-oxanorbornene, 17.4 g (66.6 mmole) 200 mL of dry THF was added. 3.97 mL (66.6 mmole) of propargyl alcohol was then added to the mixture and the flask was immersed in an ice bath. 13.5 g (66.6 mmole) of diisopropylazodicarboxylate (DIAD) was added drop-wise to the mixture. The reaction was then allowed to stir at room temperature for 16 h. After solvent was then removed under reduced pressure, the crude product was redissolved in toluene at −10° C. for 2 days upon which byproducts were precipitated out and removed by filtration. The filtrate was concentrated under reduced pressure and the product was crystallized from absolute ethanol in 90% yield.

### Example 2

C₁₆-functionalized exo-oxanorbornene (M1) was made using the procedure of example 1, with the corresponding hexadecyl alcohol.

### Example 3

Cobalt-functionalized exo-oxanorbornene (M2). 6.08 g (17.8 mmole) of cobalt octacarbonyl Co₂ (CO)₈ was added to a 500 mL round bottom flask charged with a solution of acetylene-functionalized exo-oxanorbornene (2) (3.0 g, 14.8 mmole) in CH₂Cl₂. The reaction was stirred in an ice bath for 1 h and at room temperature for another hour. The reaction mixture was concentrated under reduced pressure and the crude product was redissolved in acetone and passed through a short silica gel to remove unreacted cobalt. This process was repeated three times. The product was isolated as a dark red powder in 70% yield.

### Example 4

Polymerization procedure (˜100 kDa). 4 mL of anhydrous CH₂Cl₂ was added to a Schlenk flask containing 0.40 g (1.02 mmole) of C₁₆-functionalized exo-oxanorbornene (M1). To a separate Schlenk flask containing 0.50 g (1.02 mmole) of cobalt-functionalized exo-oxanorbornene (M2), 5 mL of anhydrous CH₂Cl₂ was added. The two flasks were degassed three times by freeze-pump-thaw cycles. A degassed solution of 3rd generation Grubbs' catalyst (7.0×10⁻³ g, 7.9×10⁻³ mmole) in 0.5 mL CH₂Cl₂ was added to the Schlenk flask containing M1 via a syringe and the monomer was allowed to polymerize for 8 min at which the solution of M2 was added via a syringe and the polymerization was allowed to continue for another 8 min before it was quenched with 0.5 mL of ethyl vinyl ether.

### Example 5

General Polymerization of Monomer. More generally, 5 mL of THF was degassed by three freeze-pump-thaw cycles. 0.20 g (55 μmol) of monomer and 2 mg (2.2 μmol) catalyst were then placed in two reaction vessels and evacuated for five minutes. A Hamilton syringe was then used to introduce 1 mL of THF to the monomer flask and 0.5 mL of THF to the catalyst. The solutions were further degassed by an additional freeze-pump-thaw cycle. After reaching room temperature, the solution of monomer was added to the catalyst solution and the reaction was stirred vigorously for 8-20 minutes. Then a second monomer solution, prepared as above, was added via syringe. This was reacted for 8-20 minutes. The polymerization was terminated by the addition of 2 mL of ethyl vinyl ether. The diblock copolymer was then precipitated from diethyl ether to yield an off-white powder. (Yield=85-95% yield)

### Example 6

General Synthesis Procedure for Monomers 1a and 1b. To a round-bottom flask charged with compound 1, alcohol derivatives, and 1.5 equiv of triphenylphosphine, THF was added. The solution mixture was then immersed in an ice bath, and 1.5 equiv of diisopropyl azodicarboxylate (DIAD) was added dropwise. After the addition of DIAD, the ice bath was removed and the reaction was allowed to stir at room temperature for 24 h. The solvent was removed under reduced pressure, and the product was crystallized from diethyl ether. The mother liquor was concentrated, and the remaining product was isolated by column chromatography.

### Example 7

Synthesis of Compound 1a. Compound 1 (6.51 g, 39.4 mmol), propargyl alcohol (2.1 mL, 35.8 mmol), triphenylphosphine (15.5 g, 59.1 mmol), diisopropylazodicarboxylate (DIAD) (11.5 mL, 59.1 mmol). The product was isolated by repeated crystallization from diethyl ether. The mother liquor was chromatographed (SiO₂ ethyl acetate/hexane=2/3). The pure product is white solid. Yield: 6.5 g (32.2 mmol, 90%). ¹H NMR (CDCl₃): δ 6.50 (s, 2H), 5.25 (s, 2H), 4.20 (s, 2H), 2.91 (s, 2H), 2.17 (s, 1H). ¹³C NMR (CDCl₃): δ 176.0, 136.6, 81.5, 78.0, 74.0, 47.0, 28.0.

### Example 8

Synthesis of Compound 1b. Compound 1 (6.34 g, 38.4 mmol), 1,2:3,4-di-O-isopropylidene-D-galactopyranose (9.84 g, 34.9 mmol), triphenylphosphine (15.1 g, 57.6 mmol), diisopropyl azodicarboxylate (DIAD) (11.2 mL, 57.6 mmol). The product was isolated by repeated crystallization from diethyl ether. The mother liquor was chromatographed (SiO₂ ethyl acetate/hexane=2/3). The pure product is white solid. Yield: 9.24 g (22.7 mmol, 65%). ¹H NMR (CDCl₃): δ 6.44 (s, 1H), 5.39 (d, 1H), 5.19 (d, 1H), 4.53 (s, 1H), 4.12 (dd, 2H), 3.95-3.88 (m, 1H), 3.36 (d, 1H), 2.80 (s, 2H), 1.42 (s, 3H), 1.38 (s, 3H), 1.27 (s, 3H), 1.21 (s, 3H). ¹³C NMR (CDCl₃): δ 176.2, 175.8, 136.4, 109.5, 108.5, 96.1, 80.7, 71.2, 70.7, 70.3, 64.1, 47.3, 47.1, 39.3, 25.8, 25.6, 24.9, 24.3.

Deprotection of the isopropylidene moiety (e.g., after copolymerization) can be achieved by using an aqueous solution of TFA (5:1 v/v). In conjunction with this invention, after copolymerization with the dicobalt monomer, the resulting copolymer solution was stirred at room temperature for one hour, and the deprotected polymer was isolated by dropwise addition into anhydrous diethyl ether.

### Example 9

Synthesis of Compound 1c. A mixture of 1-bromopentane (6.00 g, 39.7 mmol), potassium carbonate (5.48 g, 39.7 mmol), and compound 1 (4.41 g, 26.5 mmol) was stirred in anhydrous DMF (300 mL) at 50° C. for 4 h. The reaction mixture was evaporated to dryness, and the crude product was purified by chromatography (SiO₂, hexane/ethyl acetate) 1/1). Pure 1c was obtained as a white solid. Yield: 4.99 g (21.2 mmol, 80%). ¹H NMR (CDCl₃): δ 6.45 (s, 2H), 5.19 (s, 2H), 3.38 (t, 2H), 2.77 (s, 2H), 1.53-1.38 (m, 2H), 1.28-1.10 (m, 4H), 0.80 (t, 3H). ¹³C NMR (CDCl₃): δ 176.1, 136.4, 80.7, 47.2, 38.8, 31.1, 27.4, 26.1, 22.3, 13.8.

With reference to the preceding and Example 2, a wide range of hydrophobic (or hydrophilic) moieties can be introduced pendent to an appropriate monomeric component for subsequent copolymerization.

### Example 10

Synthesis of Compound 2a. To a round-bottom flask charged with compound 1a (3.62 g, 17.8 mmol), CH₂Cl₂ (100 mL) was added. The flask was immersed in an ice bath, and Co₂(CO)₈ (12.2 g, 35.6 mmol) was added and the reaction mixture was allowed to stir in an ice bath for 2 h and at room temperature for another 2 h. The solvent was removed under nitrogen flow; pentane (200 mL) was then added to remove the excess of Co₂(CO)₈ and to precipitate the product. The pure product was isolated by chromatography (SiO₂, CH₂Cl₂/acetone) 9/1). Pure 2a was obtained as a red solid. Yield: 6.53 g (13.4 mmol, 75%). ¹H NMR (CDCl₃): δ 6.50 (s, 2H), 6.00 (s, 1H), 5.27 (s, 2H), 4.80 (s, 2H), 3.89 (s, 2H). ¹³C NMR (DMSO-d₆): δ 199.3, 175.9, 136.6, 89.6, 80.4, 73.4, 47.1, 40.7.

### Example 11

General Polymerization Procedure. A known amount of monomer was weighed into a Schlenk flask, placed under an atmosphere of nitrogen, and dissolved in anhydrous CH₂Cl₂ (1 mL per 100 mg of monomer). Into a separate Schlenk flask, a desired amount of third generation Grubbs' catalyst was added, flushed with nitrogen, and dissolved in a minimum amount of anhydrous CH₂Cl₂. Both flasks were degassed three times by freeze-pump-thaw cycles. The monomer was transferred to the flask containing the catalyst via a cannula. The reaction was allowed to stir at room temperature until the polymerization is complete (˜8 min), after which ethyl vinyl ether (0.2 mL) was added to quench the polymerization. An aliquot was taken for GPC analysis, and the remaining product was precipitated from pentane.

### Example 12

General Procedure for Block Copolymer Synthesis. Known amounts of monomers A and B were weighed into two separate Schlenk flasks, placed under an atmosphere of nitrogen, and dissolved in anhydrous CH₂Cl₂ (1 mL per 100 mg of monomer). Into another Schlenk flask, a desired amount of third generation Grubbs' catalyst was added, flushed with nitrogen, and dissolved in minimum amount of anhydrous CH₂Cl₂. All three flasks were degassed three times by freeze-pump-thaw cycles. Monomer A was transferred to the flask containing the catalyst via a cannula. The reaction was allowed to stir at room temperature until the polymerization is complete (˜8 min), after which the second monomer B was added to the flask via a cannula. The polymerization was allowed to continue for another 8 min before it was quenched with ethyl vinyl ether (0.2 mL). An aliquot was taken for GPC analysis, and the remaining product was precipitated from pentane or evaporated to dryness.

### Example 13

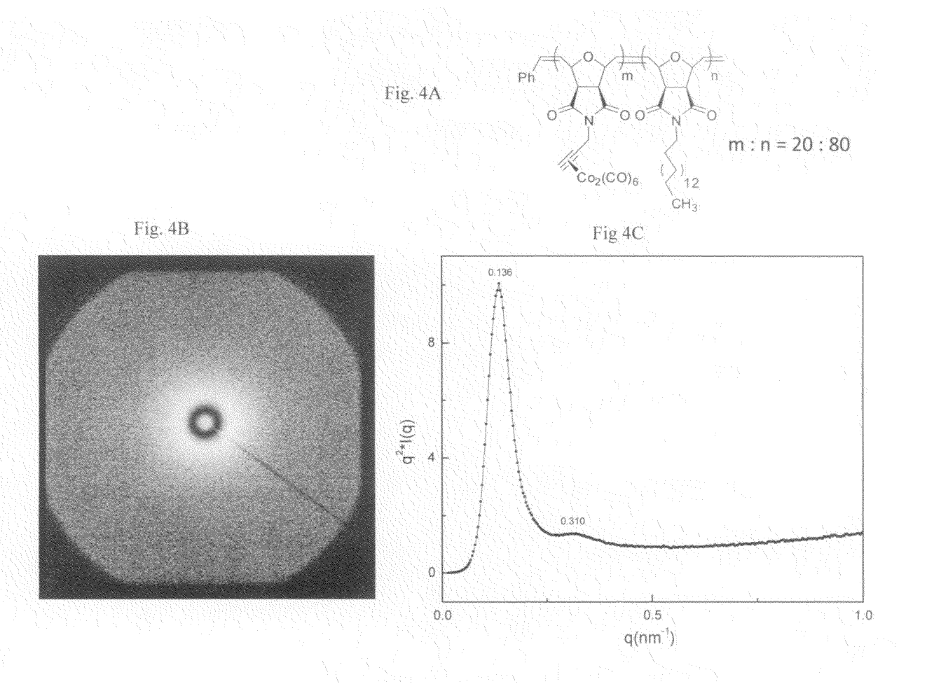

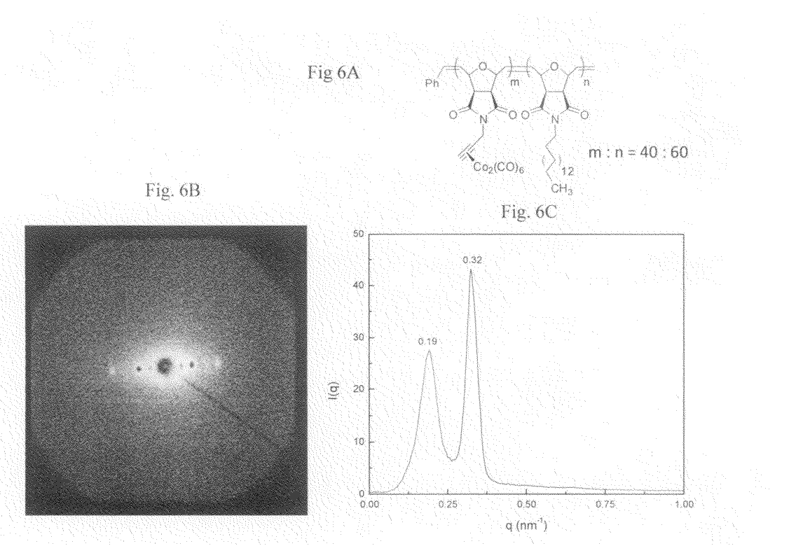

With reference to FIGS. 4-10 and the corresponding small angle x-ray scattering (B and C) and TEM (D) micrographs, various block copolymers are observed to provide different morphologies. Compositionally, each such diblock copolymer is expressed in terms of block mole fraction (m:n), but can also be considered in terms of the corresponding volume fraction. As shown, increase in metal block fraction provides change in morphology.

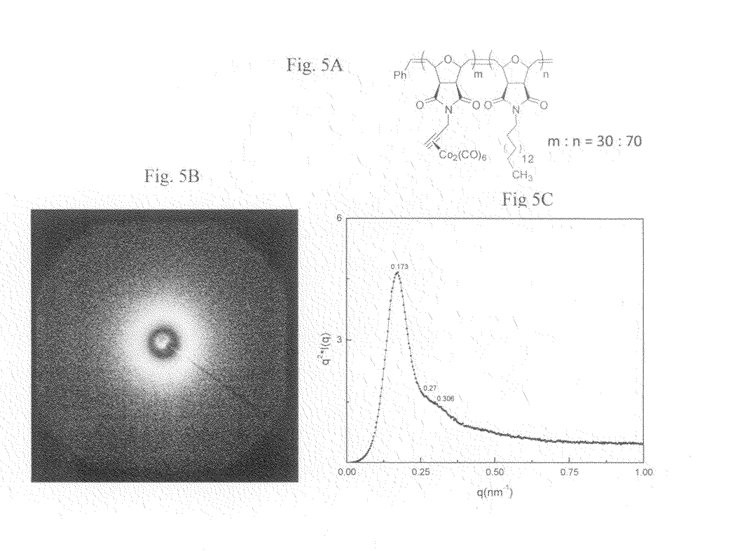

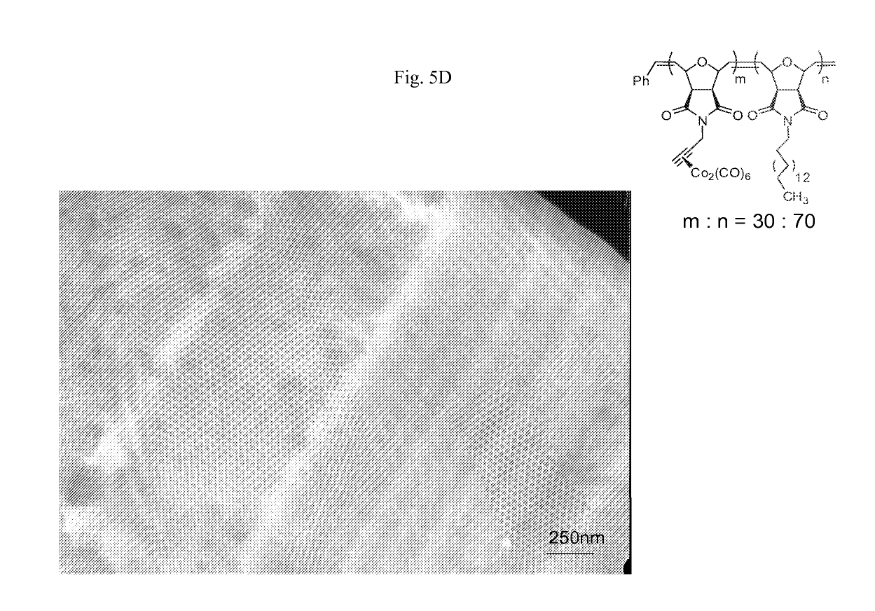

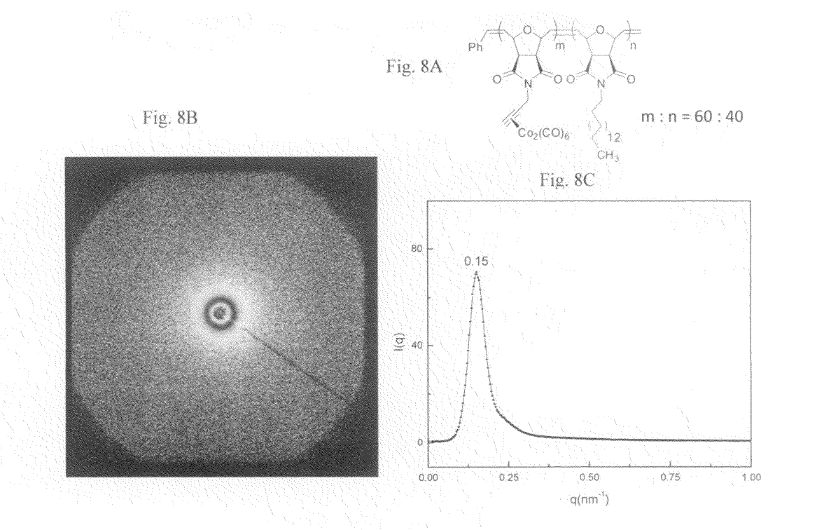

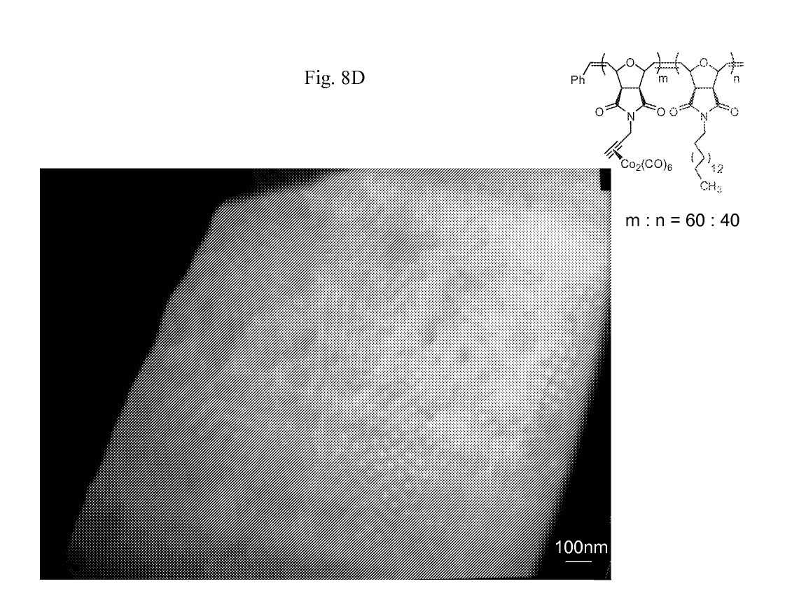

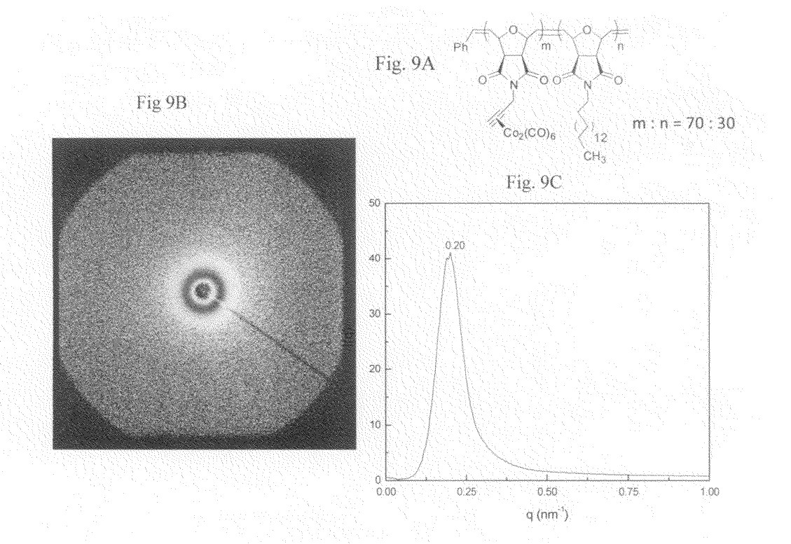

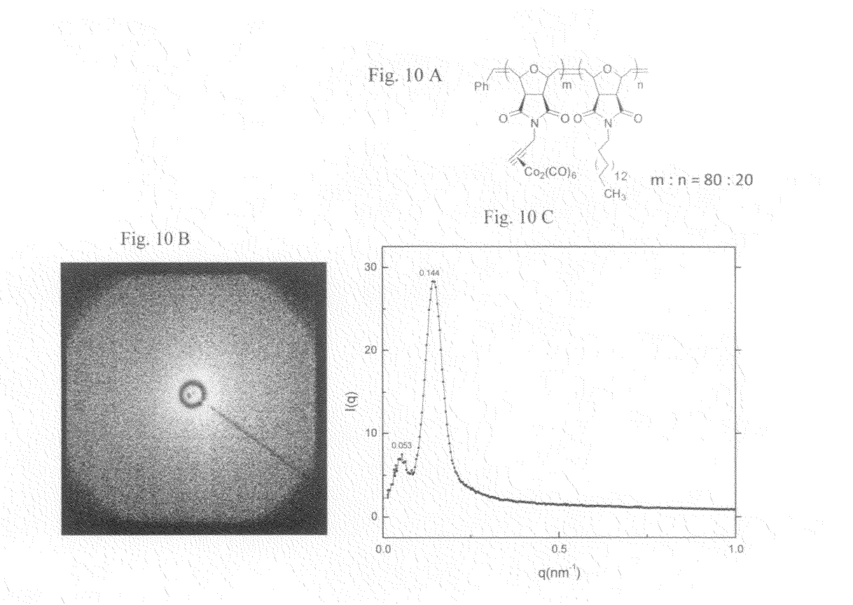

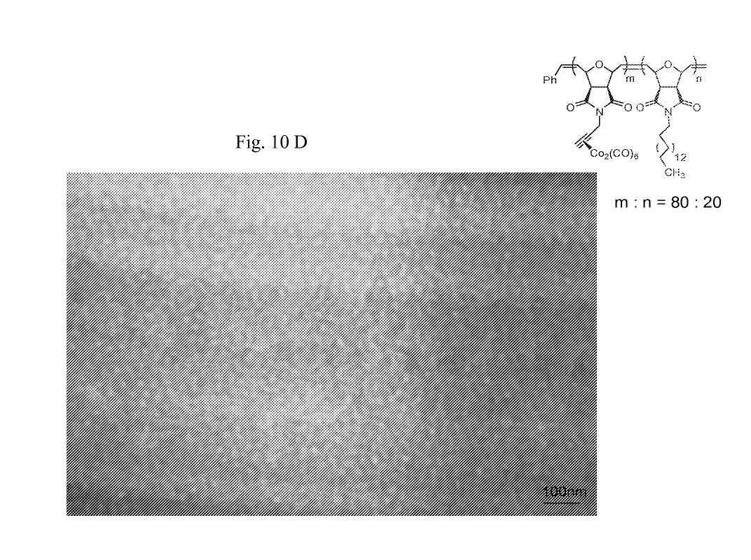

For instance, a 20:80 composition (FIG. 4) provides, after heat treatment, a spherical Co phase. Increase in metal block fraction (e.g., 30:70) provides a more defined cylindrical Co phase (e.g., FIG. 5, shown by TEM as a dark phase). At 60:40, the major Co phase is either cylindrical or lamellar (FIG. 8). Further increase in metal block fraction (e.g., 70:30) inverts the morphology, providing a cylindrical (FIG. 9) or less-defined spherical (FIG. 10) non-metal phase in a Co matrix. All such copolymers were observed to be ferromagnetic at room temperature, regardless of composition or morphology.

### Example 14

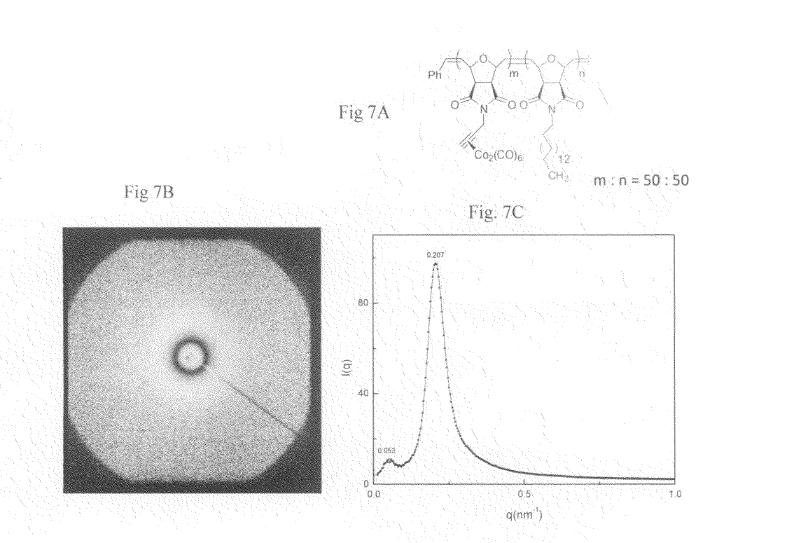

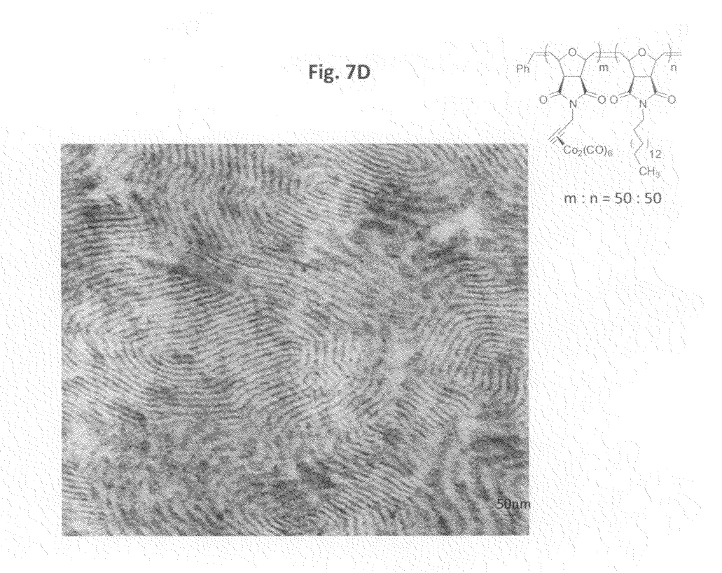

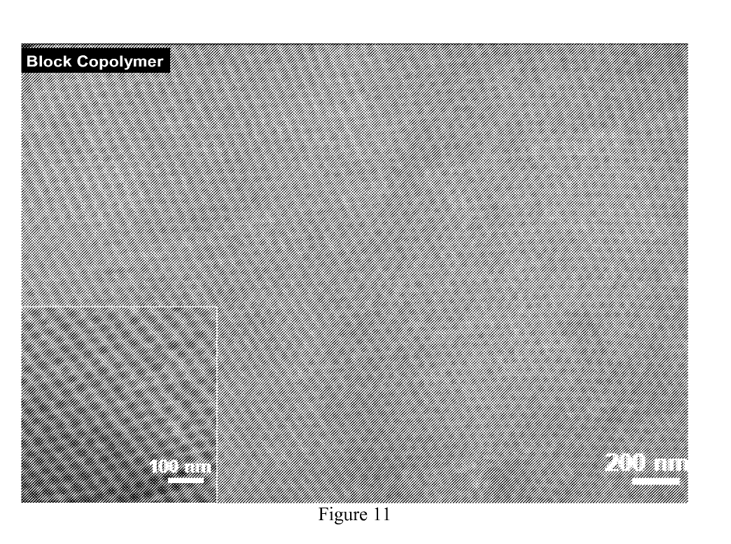

Multi-block copolymers of this invention, depending on composition and resulting morphology, can be used to fabricate thin-film composites and related articles. With reference to the TEM micrograph of FIG. 11, high-density, highly-ordered thin films, of a block co-polymer of the preceding example (50:50, FIG. 7), can be deposited on or coupled to a suitable substrate. For instance, composites/articles of the sort shown in FIG. 11 are observed after heating to provide ordered thin films with ferromagnetic cylindrical Co phases, with diameters ranging from about 2 nm to about 100 nm, over a micron (e.g., up to about 10μ) length-scale.

We claim:

1. A block copolymer comprising a first polymeric block comprising a first monomeric component comprising a metal complex R pendent thereto, said complex R a precursor to a ferromagnetic metal; and a second polymeric block comprising a second monomeric component comprising a group R₁ pendent thereto, said R₁ selected from hydrophobic and hydrophilic groups and at least partially sufficient to induce phase separation within said copolymer.

2. The copolymer of claim 1 wherein said hydrophobic R₁ group is selected from about C₅ to about C₂₄ alkyl moieties and about C₅ to about C₂₄ substituted alkyl moieties.

3. The copolymer of claim 2 wherein said metal is selected from Fe, Co and Ni.

4. The copolymer of claim 3 wherein said metal is complexed to carbonyl ligands.

5. The copolymer of claim 4 treated with heat for at least one of a time and at a temperature at least partially sufficient to remove said carbonyl ligands.

6. The copolymer of claim 5 incorporated into an article of manufacture.

7. The copolymer of claim 1 wherein said block copolymer is a ring-opening metathesis polymerization product.

8. The copolymer of claim 7 wherein at least one of said first and second blocks comprises a poly(oxanorbornene).

9. A multi-phase block copolymeric composition comprising a first phase comprising a ferromagnetic metal; and a second phase comprising a polymeric block comprising a monomeric component comprising a group R₁ pendent thereto, said R₁ selected from hydrophobic and hydrophilic groups.

10. The composition of claim 9 wherein said hydrophobic R₁ group is selected from about C₅ to about C₂₄ alkyl moieties and about C₅ to about C₂₄ substituted alkyl moieties.

11. The composition of claim 9 wherein said metal is selected from Fe, Co and Ni.

12. The composition of claim 11 wherein said metal is Co.

13. The composition of claim 12 wherein a said polymeric block comprises a poly(oxanorbornene).

14. The composition of claim 9 wherein said first phase is nanodimensioned, said composition coupled to a substrate component.

15. A method of using copolymerization to provide a ferromagnetic phase of a block copolymer, said method comprising:
providing a first monomeric component comprising a ferromagnetic metal complex R pendent thereto, and a second monomeric component comprising a group R₁ pendent thereto, said R₁ selected from hydrophobic and hydrophilic groups;
block copolymerization of said monomeric components, to provide a copolymer phase comprising said ferromagnetic metal complex; and
treating said block copolymer with an agent at least partially sufficient to provide a phase comprising a ferromagnetic metal.

16. The method of claim 15 wherein said metal is selected from Fe, Co and Ni.

17. The method of claim 16 wherein said metal is Co.

18. The method of claim 15 wherein said complex comprises carbonyl ligands and said agent comprises heat treatment for at least one of a time and at a temperature at least partially sufficient to remove said carbonyl ligands.

19. The method of claim 15 comprising deposition of said copolymer on a substrate.

20. The method of claim 15 wherein said copolymer is incorporated into an article of manufacture.

21. A cobalt-functionalized oxanorbornene compound of a formula 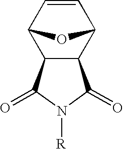
wherein R is an acetylenic moiety complexed to a ferromagnetic metal carbonyl group.

22. The compound of claim 21 wherein said metal is selected from Fe, Co and Ni.

23. The compound of claim 21 incorporated into a ring-opening metathesis polymerization product.

24. An article of manufacture comprising a thin film of a copolymeric composition of claim 9, said thin film comprising cylindrical phases of said ferromagnetic metal, said phases dimensioned about 2 nm to about 100 nm in diameter.

25. The article of claim 24 wherein said metal is selected from Fe, Co and Ni.

26. The article of claim 25 wherein a said polymeric block comprises of a poly(oxanorbornene).

27. The article of claim 24 herein said composition has a molecular weight up to about 100 kDa.

28. The article of claim 24 wherein said thin film is coupled to a substrate.
